(19) United States
(12) Patent Application Publication
(10) Pub. No.: US 2026/0086040 A1
(43) Pub. Date: Mar. 26, 2026

(54) INSPECTION SYSTEM

(71) Applicant: NEC Corporation, Minato-ku, Tokyo (JP)

(72) Inventor: Keiko INOUE, Tokyo (JP)

(73) Assignee: NEC Corporation, Minato-ku, Tokyo (JP)

(21) Appl. No.: 19/112,639

(22) PCT Filed: Oct. 13, 2022
(86) PCT No.: PCT/JP2022/038266

§ 371 Date: Mar. 18, 2025

(51) Int. Cl. G01N 21/90; G01N 21/88

(52) U.S. Cl. CPC G01N 21/9009; G01N 21/8851; G01N 21/909

(57) ABSTRACT

A system that inspects a container filled with liquid includes: a rotating unit that performs a first rotation process of setting the container in a posture laid on its side and rotating the container about a central axis of the container; and an acquiring unit that acquires an image before rotation and an image after rotation obtained by capturing a same predetermined region of the container with a camera before and after the first rotation process is performed by the rotating unit, respectively.

### TECHNICAL FIELD

The present invention relates to an inspection system, an inspection method, and a recording medium.

### BACKGROUND ART

Various devices for inspecting containers filled with liquid have been proposed or put into practical use.

For example, in Patent Literature 1, the movement trajectory of a floating object is calculated from a plurality of images obtained by continuously capturing liquid in a container kept still with a camera after shaking the container, and it is determined whether the floating object is a bubble or a foreign object based on the characteristic of the movement trajectory.

Further, in Patent Literature 2, there is disclosed an inspection apparatus that has a grasping unit grasping a container filled with liquid, a tilting unit tilting the container about a first axis in a state where the grasping unit grasps the container, and a changing unit that changes a location to capture the container with an imaging device by changing the relative orientation of the container and the imaging device about a second axis different from the first axis.

Further, in Patent Literature 3, an inspection apparatus is disclosed that, after capturing the bottom of a container in a state where the container stands upright, rotates the container to move a heavy-weight foreign object precipitated at the bottom, captures the bottom of the container again, and detects the foreign object based on a difference image between the first captured image and the second captured image.

Further, Patent Literature 4 discloses an inspection apparatus that illuminates the inside of a container from the side of the bottom surface of the container with a light placed below the container in a state where the container stands upright, and captures a liquid level illuminated by direct light from the light and reflected light from the back side of a cap with a camera placed below the container.

### CITATION LIST

### Patent Literature

Patent literature 1: WO2021/214994

Patent literature 2: WO2022/059185

Patent literature 3: Japanese Unexamined Patent Application Publication No. JP-A 2018-205199

Patent literature 4: Japanese Unexamined Patent Application Publication No. JP-A 2011-112415

### SUMMARY OF INVENTION

### Technical Problem

A foreign object may stick to the inner wall of a container filled with liquid. It has been difficult to change the sticking position of such a foreign object sticking to the inner wall of the container because it is detected distinctively from damage, dirt, and the like, of the container.

An object of the present invention is to provide an inspection system that can change the position of a foreign object sticking to the inner wall of a container.

### Solution to Problem

An inspection system according to an aspect of the present invention is an apparatus that inspects a container filled with liquid, and includes: a rotating unit that performs a first rotation process of setting the container in a posture laid on its side and rotating the container about a central axis of the container; and an acquiring unit that acquires an image before rotation and an image after rotation obtained by capturing a same predetermined region of the container with a camera before and after the first rotation process is performed by the rotating unit, respectively.

Further, an inspection method according to another aspect of the present invention is a method for inspecting a container filled with liquid, and includes: performing a first rotation process of setting the container in a posture laid on its side and rotating the container about a central axis of the container; and acquiring an image before rotation and an image after rotation obtained by capturing a same predetermined region of the container with a camera before and after the first rotation process is performed, respectively.

Further, on a computer-readable recording medium according to another aspect of the present invention, a program is recorded, and the program is for causing a computer that inspects a container filled with liquid to perform processes to: control a first rotation process of setting the container in a posture laid on its side and rotating the container about a central axis of the container; and acquiring an image before rotation and an image after rotation obtained by capturing a same predetermined region of the container with a camera before and after the first rotation process is performed, respectively.

### ADVANTAGEOUS EFFECTS OF INVENTION

With the configurations as described above, the present invention enables change of the position of a foreign object sticking to the inner wall of a container.

### BRIEF DESCRIPTION OF DRAWINGS

FIG. 1 is a configuration diagram of an inspection system according to a first example embodiment of the present invention.

FIG. 2 is a block diagram showing an example of an information processing apparatus in the inspection system according to the first example embodiment of the present invention.

FIG. 3 is a diagram showing an example of image information in the inspection system according to the first example embodiment of the present invention.

FIG. 4 is a diagram showing an example of inspection result information in the inspection system according to the first example embodiment of the present invention.

FIG. 5 is a flowchart showing an example of processing by the inspection system according to the first example embodiment of the present invention.

FIG. 6 is a diagram showing an example of a rotation angle timeline in the inspection system according to the first example embodiment of the present invention.

FIG. 7 is a schematic diagram showing a scene of capturing a vial in an upright posture with a camera device.

FIG. 8 is a schematic diagram showing a scene of capturing the vial laid on its side with the camera device.

FIG. 9 is a flowchart showing an example of processing by a detecting unit to detect a bottle-body adhering foreign object and a bottle-body damage in the first example embodiment of the present invention.

FIG. 10 is a flowchart showing an example of processing by the detecting unit to detect a lid-back adherent object in the first example embodiment of the present invention.

FIG. 11 is a flowchart showing an example of processing by the detecting unit to detect a bottom-surface damage and a bottom-surface foreign object in the first example embodiment of the present invention.

FIG. 12 is a diagram showing another example of the rotation angle timeline in the inspection system according to the first example embodiment of the present invention.

FIG. 13 is a block diagram of an inspection system according to a second example embodiment of the present invention.

### DESCRIPTION OF EXAMPLE EMBODIMENTS

Next, example embodiments of the present invention will be described in detail with reference to the drawings. In the following description, in a case where there are a plurality of elements having a common function with an element denoted by a reference sign “XXX”, they shall be distinguished from each other by providing the reference sign “XXX” with branch numbers.

### FIRST EXAMPLE EMBODIMENT

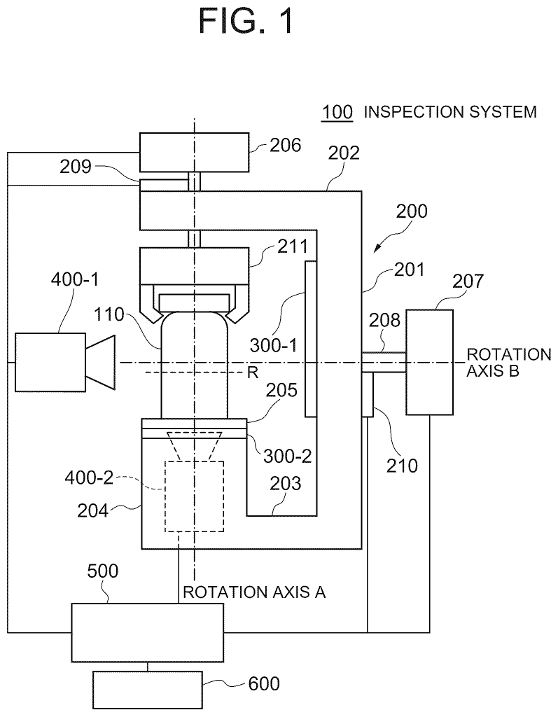

FIG. 1 is a configuration diagram of an inspection system 100 according to a first example embodiment of the present invention. Referring to FIG. 1, the inspection system 100 is a system that inspects a prefilled vial 110. The inspection system 100 includes a grasping and rotating device 200, a lighting device 300, a camera device 400, an information processing apparatus 500, and a display device 600, as main components.

The prefilled vial (hereinafter simply referred to as vial) 110 is, for example, a bottle that, in order to store a chemical agent in a sterile state, is filled with the chemical agent, stoppered with a rubber stopper at an opening part thereof, and covered with an aluminum cap in such a manner as to cover the rubber stopper. In the final process before product shipment, a plastic cap is applied to cover the aluminum cap. The lid of the vial 110 is composed of the rubber stopper, the aluminum cap, and the plastic cap. The amount of the liquid filled in the vial 110 in this example is almost half of the capacity of the vial. That is to say, a liquid level height R of the vial 110 in this example is substantially the middle of a bottle body part. However, a vial to which the present invention is applicable is not limited to the above. Moreover, the amount of the liquid filled in the vial 110 does not need to be almost half of the capacity of the vial, and may be half or more, or may be half or less. However, a vial that is fully filled with liquid and a vial that is not filled with liquid at all are not suitable as a target for inspection of a bottle-body adhering foreign object. In addition, a vial that is fully filled with liquid is not suitable as a target for inspection of a lid-back adhering object. The vial 110 may have various defects. For example, there is a possibility that a foreign object is mixed in the vial 110. Assumed foreign objects include, for example, a glass piece, a metal piece, a rubber piece, hair, a fiber piece, and soot. Moreover, the vial 110 may have a crack, a scratch, dirt, defective winding, insufficient medicine, and so forth. The inspection system 100 is a system that inspects the presence or absence of various defects that may occur in the vial 110. The inspection system 100 according to this example embodiment mainly inspects the following items.
(1) bottle-body adhering foreign object
(2) bottle-body damage
(3) lid-back adhering object
(4) bottom-surface damage

However, the items to be inspected by the inspection system 100 are not limited to the above. Items other than the above inspection items, such as a foreign object floating in the filled liquid, a foreign object precipitating on the bottom surface, insufficient medicine (insufficient entry), a foreign object floating on the liquid level, defective winding, and damage on the bottle head part, may be the inspection items.

The vial 110 includes, in order from the top in the upright posture, a winding part, a bottle head part (container head part), a truncated bottle shoulder part (container shoulder part), a cylindrical bottle body part (container body part), and a bottle bottom part that closes the bottle body part. The bottle-body adhering foreign object is a foreign object sticking to the inner wall surface of the bottle body part of the vial 110. The bottle-body adhering foreign objects are mainly fiber pieces. The size of the fiber piece is approximately a few tens of um in diameter and the length thereof is approximately several hundred um to several mm. The bottle-body damage is a crack, a scratch, dirt, and the like on the bottle body part of the vial 110. The lid-back adhering object is a foreign object adhering to the back side of the lid (the back side of the rubber stopper) of the vial 110. The bottom surface damage is a crack, a scratch, dirt, and the like on the bottle bottom part of the vial 110. The sizes to be detected of the bottle-body damage and the bottom-surface damage are in the order of mm. This is because fine damages are generally not considered a problem.

The grasping and rotating device 200 is a device that can rotate the vial 110 in a grasp state. The grasping and rotating device 200 has two rotation axes (rotation axis A and rotation axis B) that are orthogonal to each other, so that the grasped vial 110 can be rotated about the rotation axis A and can also be rotated about the rotation axis B. The grasping and rotating device 200 includes a flat plate member 201, an upper arm part 202 connected to the upper end of the flat plate member 201, and a lower arm part 203 connected to the lower end of the flat plate member 201. Moreover, the lower arm part 203 has a lower grasping part 204 at an end opposite to an end to which the flat plate member 201 is connected.

The lower grasping part 204 has a function as a pedestal for placing the vial 110, and a function as a pedestal for fixing a lighting device 300-2 and a camera device 400-2 for illuminating and capturing from the side of the bottom part of the vial 110. A rotatable transparent plate 205 is attached to the upper surface of the lower grasping part 204, and the lighting device 300-2 is attached to the lower side of the transparent plate 205. The transparent plate 205 may have a hole slightly smaller than the outer diameter of the vial 110, or may not have such a hole. The lighting device 300-2 is a ring illuminator, and illuminates the vial 110 placed on the transparent plate 205 from the side of the bottle bottom part. The camera device 400-2 is mounted in a form incorporated in the lower grasping part 204, and is attached in a position and posture that allows capture of the vial 110 from the side of the bottle bottom part.

A chuck mechanism 206 having a chuck finger 211 securing the vial 110 is provided at the end of the upper arm part 202 opposite to the end where the flat plate member 201 is connected. For example, the chuck mechanism 206 can be configured with a parallel opening and closing type air chuck, but is not limited thereto. The chuck finger 211 is rotatable about the rotation axis A and is capable of ascending and descending along the rotation axis A. The chuck mechanism 206 closes, opens, rotates, and moves up and down the chuck finger 211 in accordance with a command sent by the information processing apparatus 500. When the vial 110 is placed on the transparent plate 205 in the upright posture and the chuck finger 211 is moved down to secure the bottle head part of the vial 110, it is grasped by the grasping and rotating device 200 in such a manner that the central axis of the vial 110 (an axis passing through the center of the head part and the bottom part; also referred to as upright central axis) matches the rotation axis A. When the chuck finger 211 is rotated in this state, the vial 110 rotates about the rotation axis A. A rotation angle detector 209 such as an encoder provided at the upper arm part 202 is configured to detect the rotation angle of the chuck finger 211, accordingly, the rotation angle about the rotation axis A of the vial 110 secured by the chuck finger 211 and output to the information processing apparatus 500.

A lighting device 300-1 is a surface light source that illuminates the bottle body part of the vial 110 secured by the chuck mechanism 206 of the grasping and rotating device 200 from a direction perpendicular to the rotation axis A, and is attached to the flat plate member 201. The lighting device 300-1 is installed on the opposite side from the camera device 400-1 across the vial 110

The flat plate member 201 is axially supported by a rotation shaft 208 rotated by a motor 207. The motor 207 is fixed by a support member, which is not shown. When the rotation shaft 208 is rotated by the motor 207, the flat plate member 201 rotates. In accordance with this, all the elements directly or indirectly connected or attached to the flat plate member 201, that is, the upper arm part 202, the lower arm part 203, the lower grasping part 204, the chuck finger 211, the chuck mechanism 206, the transparent plate 205, the lighting device 300-2, the camera device 400-2, and the lighting device 300-1 rotate. Therefore, the vial 110 placed on the transparent plate 205 and secured by the chuck mechanism 206 also rotates about the rotation axis B. At this time, specifications such as dimensions and attachment positions of the respective parts of the grasping and rotating device 200 are defined in such a manner that the vial 110 rotates about an axis perpendicular to the rotation axis A and passing through the center of the vial 110. The rotation angle detector 210 such as an encoder provided at the flat plate member 201 is configured to detect a rotation angle of the rotation shaft 208, accordingly, a rotation angle about the rotation axis B of the vial 110 secured by the chuck finger 211 and output to the information processing apparatus 500.

A camera device 400-1 is a high-speed imaging device that has a wide-angle lens and continuously captures the bottle body part of the vial 110 from a predetermined position on the opposite side to the side where the lighting device 300-1 is installed as seen from the vial 110, at a predetermined frame rate (100 fps or more). The camera device 400-1 may have a telecentric lens instead of a wide-angle lens. The optical axis of the camera device 400-1 is parallel to the rotation axis B. The focus value of the camera device 400-1 is adjusted in such a manner that, for example, at least a damage on the outer wall of the bottle body part and a foreign object sticking to the inner wall close to the camera device 400-1 can be captured clearly. The camera device 400-1 may include, for example, a color camera or monochrome camera provided with a CCD (Charge-Coupled Device) image sensor or a CMOS (complementary MOS) image sensor having a pixel capacity of about several million pixels. The camera device 400-1 is connected to the information processing apparatus 500 via a wired or wireless connection. The camera device 400-1 is configured to transmit chronological images obtained by capturing to the information processing apparatus 500 together with information indicating the capture times, and the like.

The camera device 400-2 is a high-speed imaging device that has a telecentric lens and continuously captures the vial 110 secured by the chuck mechanism 206 from the side of the bottle bottom part, at a predetermined frame rate (100 fps). The camera device 400-2 may have a wide-angle lens instead of a telecentric lens. The optical axis of the camera device 400-2 is parallel to the rotation axis A. The focus value of the camera device 400-2 is adjusted in such a manner that, for example, a foreign object adhering to the back of the lid of the vial 110 can be captured clearly. In the camera device 400-2 with a thus adjusted focus value, a bottom-surface damage of the vial 110 and a foreign object precipitating on or sticking to the bottom surface thereof are captured as somewhat unclear dark regions. The camera device 400-2 may include, for example, a color camera or monochrome camera provided with a CCD image sensor or a CMOS image sensor having a pixel capacity of about several million pixels. The camera device 400-2 is connected to the information processing apparatus 500 via a wired or wireless connection. The camera device 400-2 is configured to transmit chronological images obtained by capturing to the information processing apparatus 500 together with information indicating the capture times, and the like.

The display device 600 is a display device such as an LCD (liquid crystal display). The display device 600 is connected to the information processing apparatus 500 via a wired or wireless connection. The display device 600 is configured to display the result of the inspection of the vial 110 performed by the information processing apparatus 500, and so forth.

The information processing apparatus 500 is an apparatus that performs image processing on chronological images obtained by capturing with the camera device 400 and inspects a defect of the vial 110. The information processing apparatus 500 is connected to the grasping and rotating device 200, the camera device 400, and the display device 600 via a wired or wireless connection.

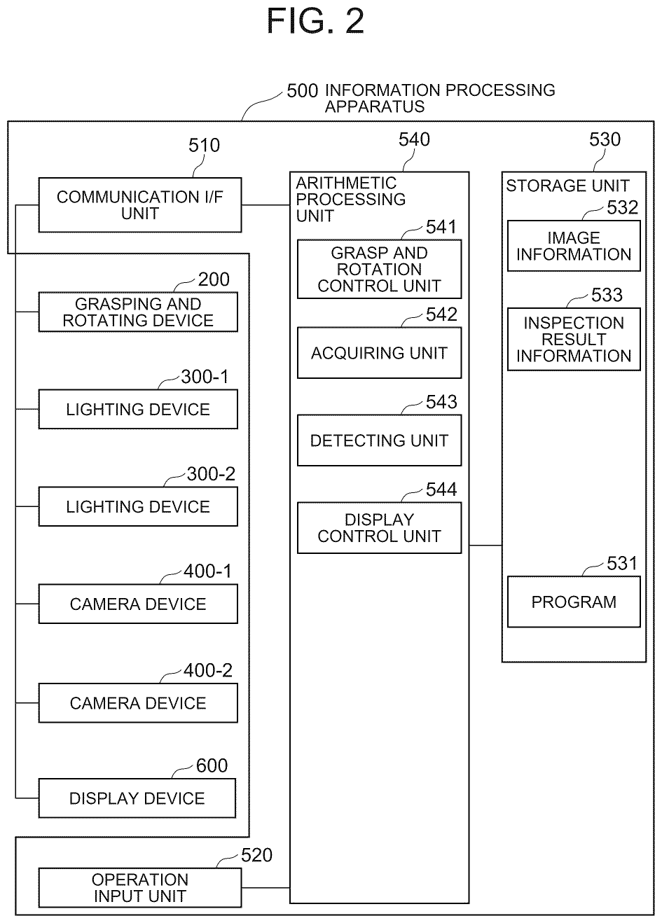

FIG. 2 is a block diagram showing an example of the information processing apparatus 500. Referring to FIG. 2, the information processing apparatus 500 includes a communication I/F unit 510, an operation input unit 520, a storage unit 530, and an arithmetic processing unit 540.

The communication I/F unit 510 is configured with a data communication circuit, and is configured to perform data communication with the grasping and rotating device 200, the lighting device 300, the camera device 400, the display device 600, and other external devices that are not shown, via a wired or wireless connection. The operation input unit 520 is configured with an operation input device such as a keyboard and a mouse, and is configured to detect an operation by an operator and output it to the arithmetic processing unit 540.

The storage unit 530 is configured with one or more storage devices of one or a plurality of types, such as a hard disk and memory, and is configured to store processing information and a program 531 necessary for various processing by the arithmetic processing unit 540. The program 531 is a program that realizes various processing units by load and execution by the arithmetic processing unit 540, and is loaded in advance from an external device or a recording medium that is not shown via a data input/output function such as the communication I/F unit 510, and stored in the storage unit 530. Main processing information stored in the storage unit 530 includes image information 532 and inspection result information 533.

The image information 532 includes chronological images obtained by continuously capturing the vial 110 with the camera device 400-1. Moreover, the image information 532 includes chronological images obtained by continuously capturing the vial 110 with the camera device 400-2.

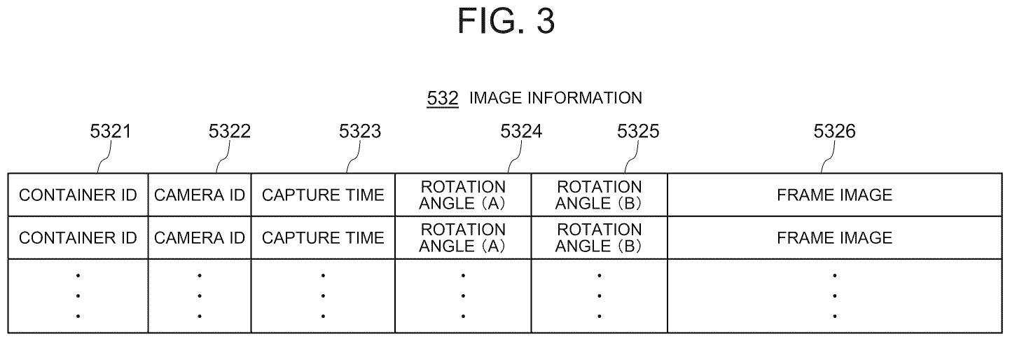

FIG. 3 shows an example configuration of the image information 532. The image information 532 in this example includes entries of container ID 5321, camera ID 5322, capture time 5323, rotation angle 5324, rotation angle 5325, and frame image 5326. An ID that uniquely identifies the vial 110 grasped by the grasping and rotating device 200 is set for the item of the container ID 5321. The possible container ID 5321 may include a serial number assigned to the vial 110, a barcode attached to the vial 110, object fingerprint information collected from the cap or the like of the vial 110, and so forth. An ID that uniquely identifies the camera device 400 having captured a frame image is set for the item of the camera ID 5322. A capture time with accuracy (e.g., in milliseconds) to allow identification from the other adjacent frame images is set for the item of the capture time 5323. A rotation angle about the rotation axis A of the vial 110 at the time of capture of the frame image is set for the item of the rotation angle 5324. A rotation angle about the rotation axis B of the vial 110 at the time of capture of the frame image is set for the item of the rotation angle 5325. The acquired frame image is set for the item of the frame image 5326. The entries of the image information 532 are arranged in order of camera ID 5322. A plurality of entries with the same camera ID 5322 are arranged in order of the capture time 5323. In the example of FIG. 3, the pair of container ID and camera ID is associated with each of the frame images 5326, but the pair of container ID and camera ID may be associated with each group of a plurality of frame images 5326.

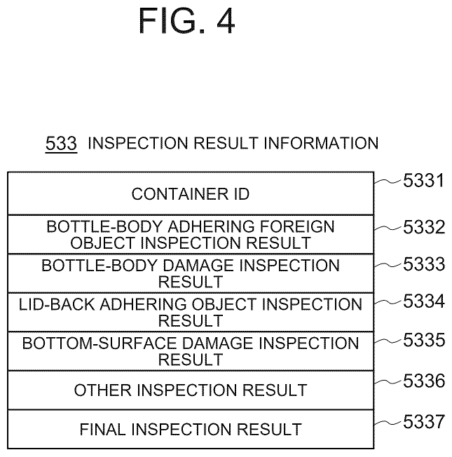

The inspection result information 533 includes information corresponding to the result of the inspection of the vial 110. FIG. 4 shows an example configuration of the inspection result information 533. The inspection result information 533 in this example includes entries of container ID 5331, bottle-body adhering foreign object inspection result 5332, bottle-body damage inspection result 5333, lid-back adhering object inspection result 5334, bottom-surface damage inspection result 5335, other inspection result 5336, and final inspection result 5337. An ID that uniquely identifies the inspection target vial 110 is set for the entry of the container ID 5331. An inspection result of either OK (inspection passed) or NG (inspection failed) is set for each of the entries of the bottle-body adhering foreign object inspection result 5332, the bottle-body damage inspection result 5333, the lid-back adhering object inspection result 5334, and the bottom-surface damage inspection result 5335. For the entry of the other inspection result 5336, in a case where an inspection of an item other than the four items of bottle-body adhering foreign object, bottle-body damage, lid-back adhering object, and bottom-surface damage has been performed on the inspection target vial 110 by the inspection system 100, an inspection result of either OK (inspection passed) or NG (inspection failed) is set for the performed inspection item. In a case where an inspection of an item other than the four items has not been performed, it is set for the entry of the other inspection result 5336 that an inspection has not been not performed. For the entry of the final inspection result 5337, OK (inspection passed) is set in a case where OK (inspection passed) is set for all the entries of the bottle-body adhering foreign object inspection result 5332, the bottle-body damage inspection result 5333, the lid-back adjuring object inspection result 5334 and the bottom-surface damage inspection result 5335, and OK (inspection passed) for all the performed inspection items is set for the entry of the other inspection result 5336 or no inspection performed is set for the entry of the other inspection result 5336. In other cases, that is, in a case where NG (inspection failure) is set for at least one of the bottle-body adhering foreign object inspection result 5332, the bottle-body damage inspection result 5333, the lid-back adhering object inspection result 5334, the bottom-surface damage inspection result 5335, and the other inspection result 5336, NG (inspection failure) is set.

The arithmetic processing unit 540 includes a processor such as a CPU (Central Processing Unit) and a peripheral circuit thereof, and is configured to load the program 531 from the storage unit 530 and execute it, thereby making the above hardware and the program 531 cooperate and realizing various processing units. Main processing units realized by the arithmetic processing unit 540 include a grasp and rotation control unit 541, an acquiring unit 542, a detecting unit 543, and a display control unit 544.

The grasp and rotation control unit 541 is configured to control the grasping and rotating device 200. The grasp and rotation control unit 541 controls motions such as descent, closing, rotation, opening, and ascent of the chuck finger 211 by transmitting and receiving signals to and from the chuck mechanism 206 of the grasping and rotating device 200 via the communication I/F unit 510. Further, the grasp and rotation control unit 541 controls rotation about the rotation axis B of the vial 110 grasped by the grasping and rotating device 200 by transmitting and receiving signals to and from the motor 207 via the communication I/F unit 510. Further, the grasp and rotation control unit 541 monitors the rotation angles about the rotation axes A and B of the vial 110 grasped by the grasping and rotating control unit 541 by transmitting and receiving signals to and from the rotation angle detectors 209 and 210 via the communication I/F unit 510.

The acquiring unit 542 is configured to control the lighting device 300 and the camera device 400. The acquiring unit 542 controls turning on and off and the like of the lighting device 300 by transmitting and receiving signals to and from the lighting device 300 via the communication I/F unit 510. Further, the acquiring unit 542 controls capture of the vial 110 grasped by the grasping and rotating device 200 by transmitting and receiving signals to and from the camera device 400 via the communication I/F unit 510, and acquires chronological images obtained by the capture. Further, the acquiring unit 542 creates the image information 532 based on the images acquired from the camera device 400 and the information on the rotation angles of about the rotation axes A and B of the vial 110 monitored by the rotation angle detectors 209 and 210, and stores it into the storage unit 530.

The detecting unit 543 is configured to inspect the presence or absence of a defect of the vial 110 based on the image information 532 acquired by the acquiring unit 542. Further, the detecting unit 543 is configured to create the inspection result information 533 based on the inspection result and store it into the storage unit 530.

The display control unit 544 is configured to output the inspection result information 533 created by the detecting unit 543 to the display device 600.

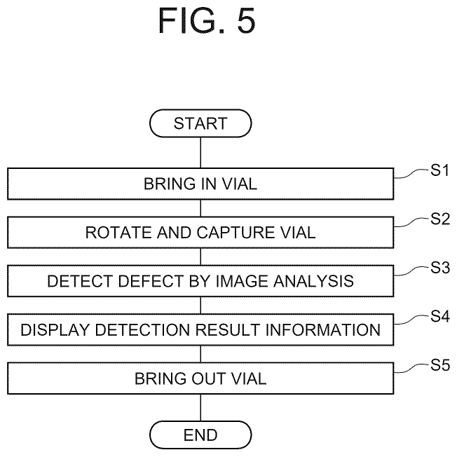

Next, the operation of the inspection system 100 according to this example embodiment will be described. FIG. 5 is a flowchart showing an example of processing by the inspection system 100. The inspection system 100 performs processing shown in FIG. 5 for each inspection target vial 110. Dust or the like that may adhere to the outside of the bottle of the inspection target vial 110 is blown away by air just before the inspection.

The grasping and rotating device 200 at the time when the processing of FIG. 5 starts is in an initial state. In the initial state, the chuck finger 211 of the grasping and rotating device 200 stops rotating in an opened and ascended state. At this time, the rotation angle about the rotation axis A detected by the rotation angle detector 209 shall be 0°. Further, the motor 207 of the grasping and rotating device 200 stops rotation about the rotation angle B of the flat plate member 201 at an angle in which the rotation axis A vertically matches. At this time, the rotation angle about the rotation axis B detected by the rotation angle detector 210 shall be 0°. In the initial state, the grasping and rotating device 200 of the inspection system 100 brings in the inspection target vial 110 (step S1). At this time, the grasp and rotation control unit 541 places the vial 110 in the upright posture at a predetermined position on the transparent plate 205 of the grasping and rotating device 200 by using, for example, a robotic arm or a manual operation, which is not illustrated. Next, the grasp and rotation control unit 541 controls the chuck mechanism 206 to descend the chuck finger 211, causing it to secure the head part of the vial 110. Consequently, the inspection target vial 110 is grasped by the grasping and rotating device 200 in the upright posture. At this time, the central axis of the vial 110 substantially matches the rotation axis A and becomes vertical.

Next, the inspection system 100 performs rotation and capture of the vial 110 (step S2). In this step S2, the grasp and rotation control unit 541 controls the chuck mechanism 206 and the motor 207 in such a manner as to rotate the vial 110 around the rotation axis A and the rotation axis B in accordance with a preset rotation angle timeline. The grasp and rotation control unit 541 gives a rotation start command specifying a rotation direction to the chuck mechanism 206 when starting rotation of the vial 110 about the rotation axis A, and gives a rotation end command to the chuck mechanism 206 when terminating the rotation. Further, the grasp and rotation control unit 541 gives a rotation start command specifying a rotation direction to the motor 207 when rotating the vial 110 around the rotation axis B, and gives a rotation end command to the motor 207 when terminating the rotation. Further, the grasp and rotation control unit 541 monitors the rotation angles about the rotation axis A and the rotation axis B detected by the rotation angle detector 209 and the rotation angle detector 210 during the rotation.

On the other hand, in step S2, when starting capture of the vial 110 with the camera device 400-1, the acquiring unit 542 gives a turn-on command to the lighting device 300-1 and gives a capture start command to the camera device 400-1 and, when terminating the capture, the acquiring unit 542 gives a turn-off command to the lighting device 300-1 and gives a capture end command to the camera device 400-1. Further, when starting capture of the vial 110 with the camera device 400-2, the acquiring unit 542 gives a turn-on command to the lighting device 300-2 and gives a capture start command to the camera device 400-2 and, when terminating the capture, the acquiring unit 542 gives a turn-off command to the lighting device 300-2 and gives a capture end command to the camera device 400-2. However, the lighting devices 300-1 and 300-2 may be turned on at all times. Further, the acquiring unit 542 may give a command to the camera device 400 to control zoom and/or focus so as to change the zoom amount and/or focus value of the camera device 400 during capture. In the case of simultaneously starting rotation and capture in step S2, the grasp and rotation control unit 541 and the acquiring unit 542 are configured to operate in a synchronized manner. For example, in a case where the vial 110 is rotated around the rotation axis A and simultaneously capture is started by the camera device 400-1, the grasp and rotation control unit 541 gives a rotation start instruction to the chuck mechanism 206, and the acquiring unit 542 gives a capture start command to the camera device 400-1 in synchronization with the rotation start command.

Further, in step S2, the acquiring unit 542 receives chronological images sent by the camera device 4r00 together with information indicating the capture times, and the like, during the capture by the camera device 400. Further, the acquiring unit 542 receives information on the monitored rotation angles about the rotation axes A and B from the rotation angle detectors 209 and 210 via the grasp and rotation control unit 541. Then, the acquiring unit 542 associates the chronological images received from the camera device 400, the capture times, and the rotation angles about the rotation axes A and B, and stores in the storage unit 530 as the image information 532. In the above, the acquiring unit 542 uses information on the monitored rotation angles about the rotation axes A and B. However, since the rotation angle timeline is set in advance and known, the processing may be performed assuming rotation starts and ends at a fixed time. That is to say, when the grasping and rotating mechanism 200 is configured to perform the operation programmed in milliseconds according to the operation start instruction by the information processing apparatus 500, the acquiring unit 542 determines the rotation angles about the rotation axes A and B automatically programmed from the time information of the operation start instruction by the information processing apparatus 500, and stores as the image information 532 in the storage unit 530 in association with the chronological images.

Next, the detecting unit 543 of the inspection system 100 inspects the presence or absence of a defect of the vial 110 based on the acquired image information 532, creates the inspection result information 533 based on the inspection result, and stores it into the storage unit 530 (step S3). Next, the display control unit 544 of the inspection system 100 displays the inspection result information 533 on the display device 600, or/and transmits it to an external device that is not illustrated via the communication I/F unit 510 (step S4). Next, the inspection system 100 brings out the vial 110 after the inspection (step S5). At this time, the grasp and rotation control unit 541 controls the chuck mechanism 206 to open the chuck finger 211 and ascend it, and then moves the vial 110 on the transparent plate 205 of the grasping and rotating device 200 to a storage location corresponding to the inspection result by using a robotic arm or a manual operation, which is not illustrated. In the above, the rotation and capture of the vial 110 (step S2) is completed, followed by defect detection by image analysis (step S3). However, the rotation and capture of the vial 110 (step S2) and defect detection by image analysis (step S3) may be performed simultaneously (sequential processing).

Subsequently, a specific example of the rotation angle timeline will be described.

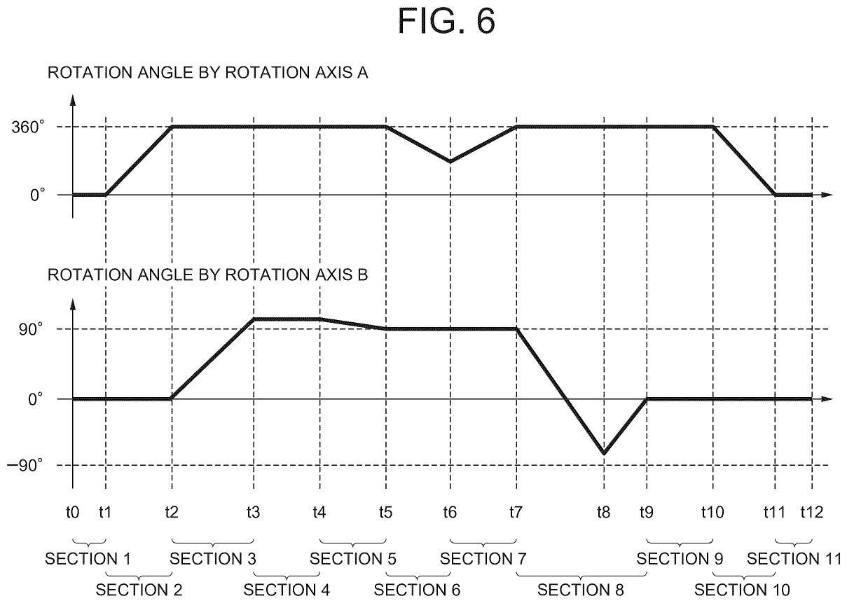

FIG. 6 is a diagram illustrating an example of the rotation angle timeline. In this example, the vial 110 is rotated in the following manner.
Section 1 (time t0-t1): Stand still in the upright posture
Section 2 (time t1-t2): Rotate 360° around the rotation axis A.
Section 3 (time t2-t3): Rotate 95° around the rotation axis B.
Section 4 (time t3-t4): Stand still in the posture in section 3
Section 5 (time t4-t5): Rotate −5° around the rotation axis B.
Section 6 (time t5-t6): Rotate −180° around the rotation axis A in the posture in Section 5, that is, in a posture laid on its side.
Section 7 (time t6-t7): Rotate 180° around the rotation axis A in the posture laid on its side.
Section 8 (time t7-t9): Rotate −170° around the rotation axis B, then immediately rotate 80°.
Section 9 (time t9-t10): Stand still in the same posture as in Section 1.
Section 10 (time t10-t11): Rotate −360° around the rotation axis A.
Section 11 (time t11-t12): Stand still in the same posture as in Section 1.

The rotation angle about the rotation axis A in Section 2 does not need to be 360° depending on the vial diameter and the thickness of the glass on the side surface of the vial, and may be a value smaller than 360°, such as 355°. In this case, the rotation angle in Section 10 becomes an angle that returns by the angle rotated in Section 2. Further, the rotation angle about the rotation axis B in Section 8 may be changed in accordance with the vial diameter and the amount of liquid filled.

In a case where the vial 110 is rotated along the rotation angle timeline shown in FIG. 6, for example, at time t0, the acquiring unit 542 sends a turn-on command to the lighting devices 300-1 and 300-2 and sends a capture start command to the camera devices 400-1 and 400-2, and at time t12, the acquiring unit 542 sends a turn-off command to the lighting devices 300-1 and 300-2 and sends a capture end command to the camera devices 400-1 and 400-2. Consequently, the vial 110 is captured by the camera devices 400-1 and 400-2 in all the sections of the rotation angle timeline in FIG. 6. However, the camera devices 400-1 and 400-2 may capture only in some limited sections.

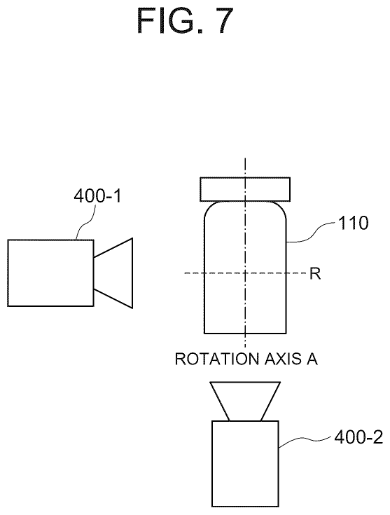

FIG. 7 is a schematic diagram showing a scene of capturing the vial 110 in the upright posture with the camera device 400-1 and the camera device 400-2 in Section 2 and Section 10. In section 2, the vial 110 rotates 360° around the rotation axis A in the upright posture, and in section 10, the vial 110 rotates −360° around the rotation axis A in the upright posture. The camera device 400-1 captures the bottle body part of the rotating vial 110 from a direction perpendicular to the rotation axis A, and the camera device 400-2 captures the rotating vial 110 from the side of the bottle bottom part of the vial 110 from a direction parallel to the rotation axis A.

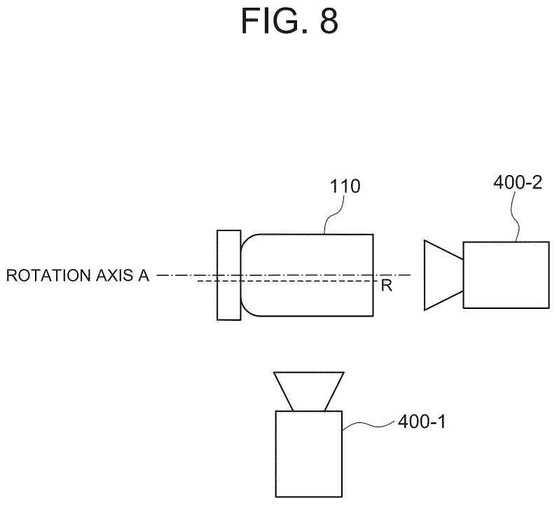

FIG. 8 is a schematic diagram showing a scene of capturing the viral 110 in a posture laid on its side with the camera device 400-1 and the camera device 400-2 in Section 6 and Section 7. In Section 6 and Section 7, the vial 110 rotates −180° and 180° around the rotation axis A in the posture laid on its side. The camera device 400-1 captures the bottle body part of the vial 110 during rotation from a direction perpendicular to the rotation axis A. On the other hand, the camera device 400-2 captures the rotating vial 110 from a direction parallel to the rotation axis A and from the side of the bottle bottom part.

Subsequently, an example of a method for inspecting a bottle-body adhering foreign object, a bottle-body damage, a lid-back adhering object, a bottom-surface damage, and the like based on the images obtained by capturing with the camera device 400 when the vial 110 is rotating along the rotation angle timeline shown in FIG. 6 will be described.

### <Inspection of Bottle-Body Adhering Foreign Object and Bottle-Body Damage>

In the process of exploring a method for inspecting a foreign object sticking to the inner wall of the bottle body part of the vial, the inventor of the present invention discovered the following phenomena. That is to say, a phenomenon was seen in which when the vial was rotated in a posture laid on its side about the central axis in such a manner that a foreign object sticking to the bottle-body inner wall passes the boundary between the inside and the outside of the liquid, the position of the foreign object sticking to the bottle-body inner wall slightly changed. Moreover, the foreign object sticking to the bottle-body inner wall of the vial is mainly a fiber piece, and a phenomenon was seen in which the shape of the sticking fiber piece changed when it was rotated as described above. As a reason for such a phenomenon to occur, it is considered that by the above rotation, the foreign object sticking to the bottle-body inner wall of the vial is pulled by the surface tension of the liquid level when passing the boundary between the inside and the outside of the liquid. Since the amount of liquid filled in the vial is almost half of the capacity of the vial as described above, as shown in FIG. 8, the liquid level height R of the vial 110 in the posture laid on its side is in the vicinity of the substantially center of the bottle body part, and the lower half of the bottle body inner wall is in the liquid and the upper half is out of the liquid. When the vial 110 is rotated −180° or more around the rotation axis A in this state, the foreign object sticking to the bottle body inner wall passes the boundary between the inside and the outside of the liquid in accordance with the rotation, and is affected by the surface tension of the liquid level at the time. In addition, by rotating the vial 110 around the rotation axis A in the posture laid on its side, the foreign object sticking to the lid back or the bottom surface of the vial 110 passes the boundary between the inside and the outside of the liquid in accordance with the rotation. Therefore, it is expected that the position and shape of the foreign object sticking to the lid back and the bottom surface will change, not only the foreign object sticking to the bottle body inner wall. When the vial 110 is rotated about the central axis in the posture laid on its side, the foreign object sticking to the inner wall may be completely detached, or a foreign object floating in the liquid may newly stick to the inner wall. In this case, the foreign object before detached and the foreign object newly sticking will be detected as a difference between the images before and after the rotation in the same manner as the foreign object sticking before and after the rotation.

Then, in this example embodiment, by comparison between an image before rotation and an image after rotation obtained by capturing the same region of the bottle body part of the vial 110 with the camera device 400-1 before and after Sections 6 and 7 in which the vial 110 is rotated around the rotation axis A in the posture laid on its side, a bottle-body adhering foreign object, a bottle-body damage, and the like, are detected distinctively.

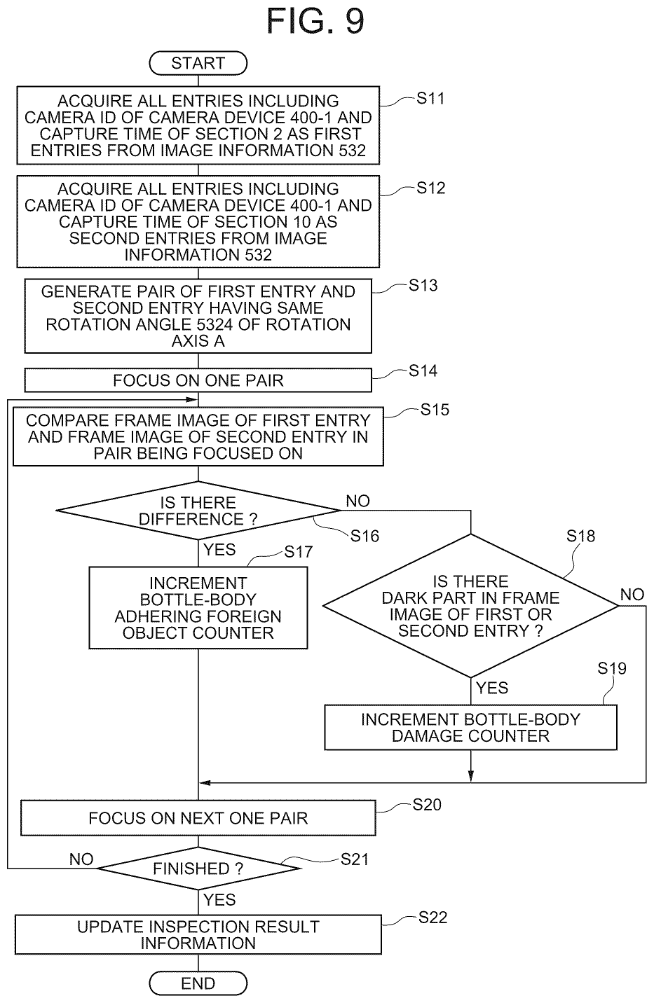

FIG. 9 is a flowchart showing an example of processing in which the detecting unit 543 detects a bottle-body adhering foreign object and a bottle-body damage. Referring to FIG. 9, the detecting unit 543 acquires all entries including the camera ID 5322 of the camera device 400-1 and the capture time 5323 included in Section 2 as first entries from the image information 532 shown in FIG. 3 (step S11). A frame image included in the first entry corresponds to the image before rotation described above. Further, the detecting unit 543 acquires all entries including the camera ID 5322 of the camera device 400-1 and the capture time 5323 included in Section 10 as second entries from the image information 532 shown in FIG. 3 (step S12). A frame image included in the second entry corresponds to the image after rotation described above.

Next, the detecting unit 543 generates all pairs of first entry and second entry including the same rotation angle 5324 of the rotation axis A (step S13). Next, the detecting unit 543 focuses on one of the pairs (step S14), compares the frame image 5326 of the first entry and the frame image 5326 of the second entry in the pair being focused on (step S15), and determines whether the bottle body part images are the same or different in the two frame images (step S16). In steps S15 and S16, the detecting unit 543 may, for example, take the difference between the bottle body part image in the frame image 5326 of the first entry and the bottle body part image in the frame image 5326 of the second entry, and determine that the images are different when there is a difference and determine that the images are the same when there is no difference. However, the method for determining whether the bottle body part images in the two frame images are the same or different is not limited to the method by difference, and any other method may be used. Next, when there is a difference between the two frame images, the detecting unit 543 determines that the difference results from a bottle-body adhering foreign object, and increments a bottle-body adhering foreign object counter (initial value is 0) (step S17). In this example, when there is a difference between the two frame images, the detecting unit immediately determines that it results from a bottle-body adhering foreign object. However, when there is a difference between the two frame images, the detecting unit may identify based on appearance information such as the shape and the color of a dark part in the frame image causing the difference whether the dark part is a foreign object such as a fiber piece or is not a foreign object but a droplet.

On the other hand, when there is no difference between the two frame images, the detecting unit 543 determines whether there is a dark part having a size equal to or more than a threshold size in the bottle body part image of the frame image of the first entry or the second entry in the pair being focused on (step S18). Since the wall of the bottle and the vicinity thereof are shown as a dark part in the bottle body part image, it may be determined whether there is a dark part having a size equal to or more than the threshold size in the remaining part (such as the middle part of the bottle body part). When there is a dark part having a size equal to or more than the threshold size, the detecting unit 543 determines that the dark part is a bottle-body damage having an unacceptable size, and increments the bottle-body damage counter (initial value is 0) (step S19). The threshold size is of the order of millimeters. This is because a damage less than the order of millimeters is not considered as a problem.

Next, the detecting unit 543 focuses on the next one of the pairs (steps S20, S21), returns to step S15, and repeats the same processing as the processing described above. Then, when the detecting unit 543 finishes focusing on all necessary pairs (YES in step S21), the detecting unit 543 updates the inspection result information 533 (step S22). The “necessary pairs” in step S21 may be, for example, a minimum number of pairs in which the entire region is visible on the front side. In step S22, the detecting unit 543 updates the bottle-body adhering foreign object inspection result 5332 and the bottle-body damage inspection result 5333 of the inspection result information 533 in which the container ID 5331 of the inspection target vial 110 is set. In updating the bottle-body adhering foreign object inspection result 5332, the detecting detection unit 543 sets NG (inspection failure) when the value of the bottle-body adhering foreign object counter is 1 or more, and sets OK (inspection passed) when it is less than 1. Further, in updating the bottle-body damage inspection result 5333, the detecting unit 543 sets NG (inspection failure) when the value of the bottle-body damage counter is 1 or more, and sets OK (inspection passed) when it is less than 1. The value of the bottle-body adhering foreign object counter, which is the measure of the number of the bottle-body adhering foreign objects, may be stored in the bottle-body adhering foreign object inspection result 5332. Likewise, the value of the bottle-body damage counter, which is the measure of the number of bottle-body damages, may be stored in the bottle-body damage inspection result 5333.

In the example shown in FIG. 9, the processing is repeated on all the necessary pairs, but when the bottle-body adhering foreign object counter or/and the bottle-body damage counter become values equal to or more than 1, the processing of step S22 may be executed immediately, followed by termination of the processing in FIG. 9.

### <Lid-Back Adhering Object>

As described above, the amount of liquid filled in the vial 110 is almost half of the capacity of the vial 110. Therefore, as shown in FIG. 8, the liquid level of the vial 110 laid on its side is substantially the middle of the bottle body part, which is a state where the liquid is not present in at least the upper half of the bottle body part. The camera device 400-2 captures the vial 110 in such a state from a direction parallel to the rotation axis A and from the bottle bottom part side. Therefore, the camera device 400-2 can capture part of the back of the lid of the vial 110 without through the liquid (accordingly, without being affected by a bubble present in the liquid). In other words, an image captured with the camera device 400-2 shows part of the back of the lid of the vial 110 captured without through the liquid. In a state where the vial 110 stands still, the range of the back of the lid that can be captured without through the liquid is limited to a part. However, in Section 6 and Section 7, the vial 110 is rotated −180° around the rotation axis A and thereafter rotated 180°, during which the camera device 400-2 captures the vial. Therefore, by gathering a plurality of frame images captured in Section 6 or/and Section 7 with the camera device 400-2, it is possible to observe the entire back of the lid without through the liquid. The detecting unit 543 detects a lid-back adhering object based on the images of the back of the lid of the vial 110 captured without through the liquid as described above.

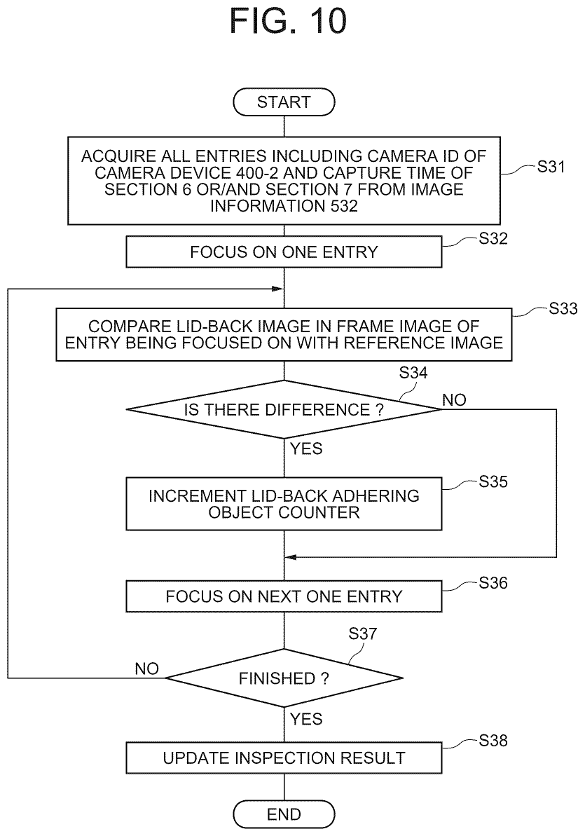

FIG. 10 is a flowchart showing an example of processing in which the detecting unit 543 detects a lid-back adhering object. Referring to FIG. 10, the detecting unit 543 acquires all the entries including the camera ID 5322 of the camera device 400-2 and the capture time 5323 included in Section 6 or/and Section 7 from the image information 532 shown in FIG. 3 (step S31). Next, the detecting unit 543 focuses on one of the entries (step S32). Next, the detecting unit 543 compares the frame image 5326 of the entry being focused on with a reference image (not shown) stored in the storage unit 530 (step S33), and determines whether the two images are the same or different (step S34). The shape and color of the back of the lid of the vial 110 are determined for each type of vial. The reference image is obtained by previously capturing the lid back of a vial with no lid-back adhering object, which is of the same type as the inspection target vial 110, with the camera device 400-2 and is stored in the storage unit 530. In step S33, the detecting unit 543 may, for example, take the difference between the frame image 5326 and the reference image, and determine that the images are different when there is a difference and determine that the images are the same when there is no difference. The range of the frame image 5326 to take the difference from the reference image may be the entire frame image 5326, may be the entire range of the back of the lid in the frame image 5326, or may be limited to the range of the back of the lid captured without via the liquid. Further, the method for determining whether the frame image 5326 and the reference image are the same or different is not limited to the method by difference, and any other method may be used.

Next, when there is a difference between the frame image 5326 and the reference image, the detecting unit 543 determines that the difference results from a lid-back adhering object, and increments the lid-back adhering object counter (initial value is 0) (step S35). In this example, when there is a difference between the frame image 5326 and the reference image, the detecting unit immediately determines that it is a lid-back adhering object. However, when there is a difference between the frame image 5326 and the reference image, the detecting unit may identify based on appearance information such as the shape and color in the vicinity of the different portion (difference portion), whether there is actually a foreign object in the difference portion, whether there is not a foreign object but a droplet, and the like.

On the other hand, when there is no difference between the frame image 5326 and the reference image, the detecting unit 543 skips step S35. Next, the detecting unit 543 focuses on the next one of the entries (steps S36, S37), returns to step S33, and repeats the same processing as the processing described above. Then, when the detecting unit 543 finishes focusing on all the entries (YES in step S37), the detecting unit 543 updates the inspection result information 533 (step S38). In this step S38, the detecting unit 543 updates the lid-back adhering object inspection result 5334 of the inspection result information 533 in which the container ID 5331 of the inspection target vial 110 is set. In updating the lid-back adhering object inspection result 5334, the detecting unit 543 sets NG (inspection failed) when the value of the lid-back adhering object counter is 1 or more, and sets OK (inspection passed) when it is less than 1. The value of the lid-back adhering object counter, which serves as the measure of the number of lid-back adhering objects, may be stored in the lid-back adhering object inspection result 5334.

In the example shown in FIG. 10, the processing is repeatedly executed on all the entries, but when the lid-back adhering object counter becomes a value equal to or more than 1, the processing of step S38 may be executed immediately, followed by termination of the processing in FIG. 10.

### <Inspection of Bottom-Surface Damage and Bottom-Surface Foreign Object>

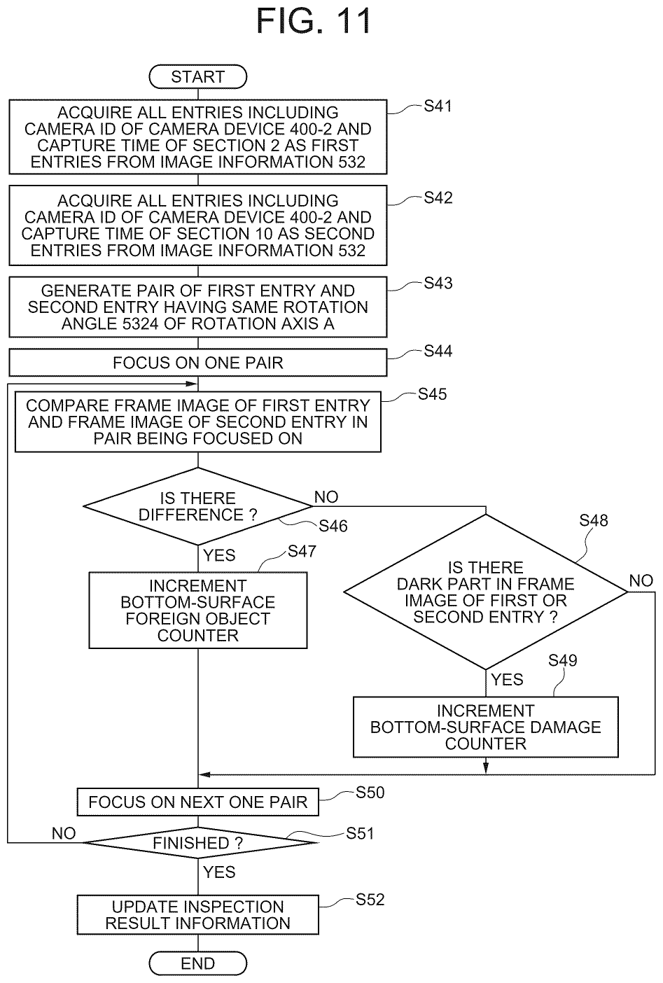

FIG. 11 is a flowchart showing an example of processing in which the detecting unit 543 detects a bottom-surface damage and a bottom-surface foreign object. Referring to FIG. 11, the detecting unit 543 acquires all entries including the camera ID 5322 of the camera device 400-2 and the capture time 5323 included in Section 2 as first entries from the image information 532 shown in FIG. 3 (step S41). A frame image included in this first entry corresponds to an image obtained by capturing the vial 110 from the bottle bottom side with the camera device 400-2 before rotating the vial 110 lied on its side around the rotation axis A. Further, the detecting unit 543 acquires all entries including the camera ID 5322 of the camera device 400-2 and the capture time 5323 included in Section 10 as second entries from the image information 532 shown in FIG. 3 (step S42). A frame image included in this second entry corresponds to an image obtained by capturing the vial 110 from the bottle bottom side with the camera device 400-2 after rotating the vial 110 lied on its side about the rotation axis A.

Next, the detecting unit 543 generates a pair of first entry and second entry including the same rotation angle 5324 of the rotation axis A (step S43). Next, the detecting unit 543 focuses on one of the pairs (step S44), compares the frame image 5326 of the first entry and the frame image 5326 of the second entry in the pair being focused on (step S45), and determines whether the two frame images are the same or different (step S46). In step S45, the detecting unit 543 may, for example, take the difference between the image of the bottle bottom part in the frame image 5326 of the first entry and the image of the bottle bottom part in the frame image 5326 of the second entry, and determine that the images are different when there is a difference and determine that the images are the same when there is no difference. However, the method for determining whether the bottle bottom part images of the two frame images are the same or different is not limited to the method by difference, and any other method may be used. Next, when there is a difference between the two frame images, the detecting unit 543 determines that the difference results from a foreign object precipitating on or sticking to the bottom surface of the vial 110, and increments the bottom-surface foreign object counter (initial value is 0) (step S47). In this example, when there is a difference between the two frame images, the detecting unit immediately determines that there is a bottom-surface foreign object. However, when there is a difference between the two frame images, the detecting unit may identify based on appearance information such as the shape and color of a dark part of the frame image causing the difference whether the dark part is a foreign object such as a metal piece and a fiber piece or is not a foreign object but a huge bubble.

On the other hand, when there is no difference between the two frame images, the detecting unit 543 determines whether there is a dark part having a size equal to or more than a threshold size in the frame image of the first entry or the second entry in the pair being focused on (step S48). Since the wall of the bottle and the vicinity thereof are shown as a dark part in the image of the bottle bottom part, it may be determined whether there is a dark part having a size equal to or more than the threshold size in the remaining part (such as the middle part of the bottle bottom part). When there is a dark part having a size equal to or more than the threshold size, the detecting unit 543 determines that the dark part is a bottom-surface damage having an unacceptable size, and increments the bottom-surface damage counter (initial value is 0) (step S49). The threshold size is of the order of millimeters. This is because a damage less than the order of millimeters is not considered as a problem.

Next, the detecting unit 543 focuses on the next one of the pairs (steps S50, S51), returns to step S45, and repeats the same processing as the processing described above. Then, when the detecting unit 543 finishes focusing on all the pairs (YES in step S51), the detecting unit 543 updates the inspection result information 533 (step S52). In this step S52, the detecting unit 543 updates the bottle-surface damage inspection result 5335 and the other inspection result 5336 of the inspection result information 533 in which the container ID 5331 of the inspection target vial 110 is set. In updating the bottle-surface damage inspection result 5335, the detecting unit 543 sets NG (inspection failure) when the value of the bottom-surface damage counter is 1 or more, and sets OK (inspection passed) when it is less than 1. Further, in updating the other inspection result 5336, when the value of the bottom-surface foreign object counter is 1 or more, the detecting unit 543 adds an inspection item of bottom-surface foreign object to the other inspection result 5336 and sets NG (inspection failure), and when it is less than 1, sets OK (inspection passed). The values of the bottom-surface damage counter and the bottom-surface foreign object counter, which are the measures of the numbers of bottom-surface damages and bottom-surface foreign objects, may be stored in the bottom-surface damage inspection result 5335 and the inspection item of bottom surface of the other inspection result 5336.

In the example shown in FIG. 11, the processing is repeatedly executed on all the pairs, but when the bottom-surface damage counter or/and the bottom-surface foreign object counter reaches values equal to or more than 1, the processing of step S52 may be executed immediately, followed by termination of the processing in FIG. 11.

As illustrated above, the inspection system 100 according to this example embodiment performs a process of laying the vial 110 on its side and rotating the vial 110 about its central axis (rotation axis A) (Section 6 or Section 7 in FIG. 6). Consequently, a foreign object sticking to the inner wall of the vial 110 is pulled due to the surface tension of the liquid level when passing the boundary between the inside and the outside of the liquid, and a phenomenon is thereby induced in which the position and shape of the foreign object change. That is to say, it is possible to change the position of the foreign object sticking to the inner wall of the vial 110. Then, the inspection system 100 acquires an image before rotation (image of Section 2 of FIG. 6) and an image after rotation (image of Section 10 of FIG. 6) obtained by capturing the same predetermined region such as the bottle body part of the vial 110 with the camera device 400 before and after the above-described process is performed, respectively. Therefore, by providing the detecting unit 543 that compares an image before rotation with an image after rotation and detects a foreign object adhering to the inner wall of a container, it is possible to detect a foreign object sticking to the inner wall of the vial 110 distinctively from a damage that does not change in position or shape even if the above process is performed.

Further, the inspection system 100 according to this example embodiment lays the vial 110 on its side and rotates the vial 110 about its central axis (rotation axis A), and acquires an image (image of Section 6 or Section 7 of FIG. 6) obtained by capturing the back side of the lid through a region outside the liquid from the side of the bottom part of the vial 110 being rotated with the camera device 400-2 having an optical axis parallel to the central axis (rotation axis A). Therefore, the camera device 400-2 can capture part of the back of the lid of the vial 110 without through inside the liquid. That is to say, an image captured with the camera device 400-2 shows part of the back of the lid of the vial 110 captured without through inside the liquid. As a result, a foreign object adhering to the back of the lid can be accurately detected. In addition, because the camera device 400-2 having a telecentric lens is used, it is possible to avoid showing the liquid level as much as possible (in such a manner that the thickness of a liquid level contour part in the image is reduced), and it is possible to show large the back of the lid, which is a site the farthest away from the camera.

This example embodiment can be changed in various ways as follows.

Although a vial is subject to inspection, a bottle or a container other than a vial may also be subject to inspection as long as it is a transparent or translucent container filled with liquid such as drinking water

In the above description, the inspection system 100 rotates the vial 110 about the rotation axis A −180° (half turn) and then rotates 180° (half turn), in Section 6 and Section 7 in the rotation angle timeline of FIG. 6, but that is merely an example. In a case where the amount of the liquid is almost half of the capacity of the vial, the inspection system may rotate the vial 110 about the rotation axis A at least 180° (half turn) in a positive direction or a negative direction. This is because the whole region of the inner wall of the bottle body part will pass the boundary between the inside and the outside of the liquid one time or more. Alternatively, the inspection system 100 may detect the amount of the liquid filled and determine the amount of rotation in Section 6 and Section 7 in accordance with the detected amount of the liquid. For example, the inspection system 100 may detect the height of the liquid level of the vial 110 laid on its side by image analysis or the like, and calculate from the detected height of the liquid level a minimum rotation angle about the rotation axis A necessary for all the regions of the inner wall of the bottle body part of the vial 110 to pass the boundary between the inside of and outside of the liquid at least one time, and rotate the vial 110 about the rotation axis A by at least the calculated minimum rotation angle. Alternatively, in a case where the liquid is filled, when the vial 110 is rotated about the rotation axis A at least 360° (full turn) in the positive direction or the negative direction, all the regions of the inner wall of the bottle body part of the vial 110 will pass the boundary between the inside and outside of the liquid one time certainly. Therefore, the vial 110 may be rotated about the rotation axis A by at least 360° (full turn) in the positive direction or the negative direction. Further, the inspection system 100 rotates the vial 110 one time about the rotation axis A in Section 2 and Section 10 in the rotation angle timeline of FIG. 6, but may rotate one time or more (e.g., two times or more), respectively. Further, in Section 8 in the rotation angle timeline of FIG. 6, the inspection system 100 rotates the vial 110 around the rotation axis B −170° and then immediately rotates 80°. Since this is mainly to float a foreign object in the vial 110 in the liquid to increase the efficiency of detection of a floating foreign object, the inspection system 100 may only rotate the vial 110 around the rotation axis B −90° in a case where it does not perform detection of a floating foreign object. That is to say, the inspection system 100 may only return the vial 110 laid on its side to the upright posture in Section 8.

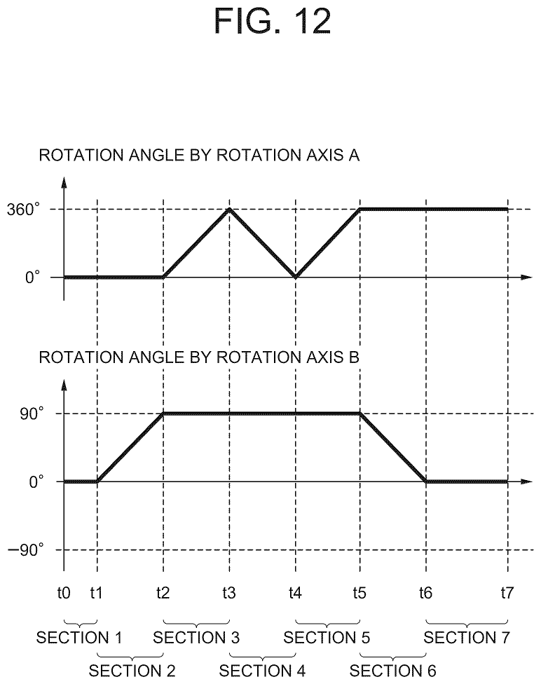

Further, the inspection system 100 may use a section in which the vial 110 is laid on its side and rotated about its central axis (rotation axis A), as a section in which the same predetermined region such as the bottle body part of the vial 110 is captured with the camera device 400 before and after the process of laying the vial 110 on its side and rotating about its central axis (rotation axis A) (Section 6 or Section 7 of FIG. 6). Hereinafter it will be described in detail with reference to FIG. 12.

FIG. 12 is a diagram showing another example of the rotation angle timeline. In this example, the vial 110 is rotated in the following manner.
Section 1 (time t0-t1): Stand still in the upright posture
Section 2 (time t1-t2): Rotate 90° around the rotation axis B.
Section 3 (time t2-t3): Rotate 360° around the rotation axis A in the posture laid on its side.
Section 4 (time t3-t4): Rotate −360° around the rotation axis A in the posture laid on its side.
Section 5 (time t4-t5): Rotate 360° around the rotation axis A in the posture laid on its side.
Section 6 (time t5-t6): Rotate −90° around the rotation axis B.
Section 7 (time t6-t7): Stand still in the same posture as in Section 1.

Section 4 in FIG. 12 is a process of laying the vial 110 on its side and rotating about its central axis (rotation axis A) at least one time, and Section 3 and Section 5 are processes of capturing the same predetermined region such as the bottle body part of the vial 110 with the camera device 400 before and after the abovementioned process, respectively.

### SECOND EXAMPLE EMBODIMENT

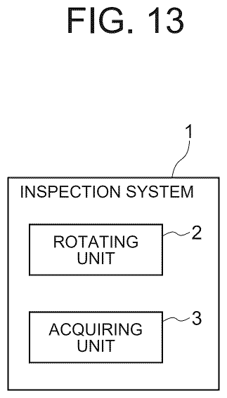

Next, a second example embodiment of the present invention will be described with reference to FIG. 13. FIG. 13 is a block diagram showing a configuration of an inspection system 1 in this example embodiment. Referring to FIG. 13, the inspection system 1 is an apparatus that inspects a container filled with liquid, and includes a rotating unit 2 and an acquiring unit 3.

The rotating unit 2 is configured to perform a first rotation process of laying a container on its side and rotating the container about a central axis of the container. The rotating unit 2 can be configured in the same manner as, for example, the grasping and rotating device 200 of FIG. 1, but is not limited thereto.

The acquiring unit 3 is configured to acquire an image before rotation and an image after rotation obtained by capturing the same predetermined region of the container with a camera before and after the above-described first rotation process is performed by the rotating unit 2. The acquiring unit 3 can be configured in the same manner as, for example, the acquiring unit 542 of FIG. 2, but is not limited thereto.

The inspection system 1 configured in this manner operates in the following manner. That is to say, the rotating unit 2 performs the first rotation process of laying a container on its side and rotating the container about the central axis of the container. The acquiring unit 3 acquires an image before rotation and an image after rotation obtained by capturing the same predetermined region of the container with a camera before and after the above-described first rotation process is performed by the rotating unit 2.

According to the inspection system 1 that is configured and operates as described above, the first rotation process induces a phenomenon in which a foreign object sticking to the inner wall of a container is pulled due to the surface tension of the liquid level when passing the boundary between the inside and outside of the liquid and the position of the foreign object changes. That is to say, it is possible to change the position of a foreign object sticking to the inner wall of a container. Then, the inspection apparatus 1 acquires an image before rotation and an image after rotation obtained by capturing the same predetermined region of a container with a camera before and after the first rotation process is performed, respectively. Therefore, for example, by providing a detecting unit that compares an image before rotation with an image after rotation and detects a foreign object adhering to the inner wall of a container, it is possible to detect the foreign object sticking to the inner wall of the container distinctively from a damage that does not change in position or shape even if the first rotation process is performed.

Although the present invention has been described above with reference to the above example embodiments, the present invention is not limited to the example embodiments described above. The configuration and details of the present invention can be changed in various manners that can be understood by one skilled in the art within the scope of the present invention. For example, the information processing apparatus may use a GPU (Graphic Processing Unit), a DSP (Digital Signal Processor), an MPU (Micro Processing Unit), an FPU (Floating Number Processing Unit), a PPU (Physics Processing Unit), a TPU (Tensor Processing Unit), a quantum processor, a microcontroller, or a combination of these, instead of the abovementioned CPU.

### Industrial Applicability

The present invention can be used in the field of inspecting a container such as a vial filled with liquid.

The whole or part of the above example embodiments can be described as the following supplementary notes, but is not limited to the following.

### [Supplementary Note 1]

An inspection system that inspects a container filled with liquid, the inspection system comprising:
a rotating unit that performs a first rotation process of setting the container in a posture laid on its side and rotating the container about a central axis of the container; and
an acquiring unit that acquires an image before rotation and an image after rotation obtained by capturing a same predetermined region of the container with a camera before and after the first rotation process is performed by the rotating unit, respectively.

### [Supplementary Note 2]

The inspection system according to supplementary note 1, wherein:
the rotating unit performs a second rotation process of setting the container in an upright posture and rotating the container about the central axis before the first rotation process, and performs a third rotation process of setting the container in the upright posture and rotating the container about the central axis after the first rotation process; and
the acquiring unit acquires the image before rotation from an image obtained by capturing with the camera during the second rotation process, and acquires the image after rotation from an image obtained by capturing with the camera during the third rotation process.

### [Supplementary Note 3]

The inspection system according to supplementary note 1 or 2, wherein:
the rotating unit performs a second rotation process of setting the container in the posture laid on its side and rotating the container about the central axis of the container before the first rotation process, and performs a third rotation process of setting the container in the posture laid on its side and rotating the container about the central axis of the container after the first rotation process; and
the acquiring unit acquires the image before rotation from an image obtained by capturing with the camera during the second rotation process, and acquires the image after rotation from an image obtained by capturing with the camera during the third rotation process.

### [Supplementary Note 4]

The inspection system according to any of supplementary notes 1 to 3, further comprising
a detecting unit that compares the image before rotation with the image after rotation, and detects a foreign object adhering to an inner wall of the container.

### [Supplementary Note 5]

The inspection system according to supplementary note 4, wherein
the detecting unit further compares the image before rotation with the image after rotation, and detects a damage of the container.

### [Supplementary Note 6]

The inspection system according to any of supplementary notes 1 to 5, wherein
the camera has an optical axis perpendicular to the central axis.

### [Supplementary Note 7]

The inspection system according to supplementary note 6, wherein
the predetermined region includes a body part of the container.

### [Supplementary Note 8]

The inspection system according to any of supplementary notes 1 to 5, wherein
the camera has an optical axis parallel to the central axis.

### [Supplementary Note 9]

The inspection system according to supplementary note 8, wherein
the predetermined region includes a bottom surface region of the container.

### [Supplementary Note 10]

The inspection system according to supplementary note 8, wherein
the predetermined region includes a region of a back of a lid of the container.

### [Supplementary Note 11]

The inspection system according to any of supplementary notes 1 to 10, wherein
the camera has a wide-angle lens.

### [Supplementary Note 12]

The inspection system according to any of supplementary notes 1 to 10, wherein
the camera has a telecentric lens.

### [Supplementary Note 13]

The inspection system according to any of supplementary notes 1 to 12, wherein
the rotating unit rotates the container in such a manner that an almost whole region of an inner wall of the container passes a boundary between inside the liquid and outside the liquid at least one time in the first rotation process.

### [Supplementary Note 14]

The inspection system according to any of supplementary notes 1 to 13, wherein
the rotating unit rotates the container at least a half turn about the central axis of the container in the first rotation process.

### [Supplementary Note 15]

The inspection system according to any of supplementary notes 1 to 13, wherein
the rotating unit rotates the container at least one time about the central axis of the container in the first rotation process.

### [Supplementary Note 16]

The inspection system according to any of supplementary notes 1 to 13, wherein
the rotating unit rotates the container at least a half turn about the central axis of the container and thereafter rotates a half turn in an opposite direction in the first rotation process.

### [Supplementary Note 17]

An inspection method for inspecting a container filled with liquid, the inspection method comprising:
performing a first rotation process of setting the container in a posture laid on its side and rotating the container about a central axis of the container; and
acquiring an image before rotation and an image after rotation obtained by capturing a same predetermined region of the container with a camera before and after the first rotation process is performed, respectively.

### [Supplementary Note 18]

The inspection method according to supplementary note 17, comprising:
performing a second rotation process of setting the container in an upright posture and rotating the container about the central axis before the first rotation process;
performing a third rotation process of setting the container in the upright posture and rotating the container about the central axis after the first rotation process; and
in the acquiring, acquiring the image before rotation from an image obtained by capturing with the camera during the second rotation process, and acquiring the image after rotation from an image obtained by capturing with the camera during the third rotation process. [Supplementary Note 19]

The inspection method according to supplementary note 17 or 18, comprising:
performing a second rotation process of setting the container in the posture laid on its side and rotating the container about the central axis of the container before the first rotation process;
performing a third rotation process of setting the container in the posture laid on its side and rotating the container about the central axis of the container after the first rotation process; and
in the acquiring, acquiring the image before rotation from an image obtained by capturing with the camera during the second rotation process, and acquiring the image after rotation from an image obtained by capturing with the camera during the third rotation process.

### [Supplementary Note 20]

The inspection method according to any of supplementary notes 17 to 19, further comprising
comparing the image before rotation with the image after rotation, and detecting a foreign object adhering to an inner wall of the container.

### [Supplementary Note 21]

The inspection method according to supplementary note 20, comprising
in the detecting, further comparing the image before rotation with the image after rotation, and detecting a damage of the container.

### [Supplementary Note 22]

The inspection method according to any of supplementary notes 17 to 21, wherein
the camera has an optical axis perpendicular to the central axis.

### [Supplementary Note 23]

The inspection method according to supplementary note 22, wherein
the predetermined region includes a body part of the container.

### [Supplementary Note 24]

The inspection method according to any of supplementary notes 17 to 21, wherein
the camera has an optical axis parallel to the central axis.

### [Supplementary Note 25]

The inspection method according to supplementary note 24, wherein
the predetermined region includes a bottom surface region of the container.

### [Supplementary Note 26]

The inspection method according to supplementary note 20, wherein
the predetermined region includes a region of a back of a lid of the container.

### [Supplementary Note 27]

The inspection method according to any of supplementary notes 13 to 22, wherein
the camera has a wide-angle lens.

### [Supplementary Note 28]

The inspection method according to any of supplementary notes 13 to 22, wherein
the camera has a telecentric lens.

### [Supplementary Note 29]

The inspection method according to any of supplementary notes 13 to 22, comprising
in the first rotation process, rotating the container in such a manner that an almost whole region of an inner wall of the container passes a boundary between inside the liquid and outside the liquid at least one time.

### [Supplementary Note 30]

The inspection method according to any of supplementary notes 13 to 25, comprising
in the first rotation process, rotating the container at least a half turn about the central axis of the container.
   [supplementary Note 31]

The inspection method according to any of supplementary notes 13 to 25, comprising
in the first rotation process, rotating the container at least one time about the central axis of the container.

### [Supplementary Note 32]

The inspection method according to any of supplementary notes 13 to 25, comprising
in the first rotation process, rotating the container at least a half turn about the central axis of the container and thereafter rotating a half turn in an opposite direction.
   [supplementary Note 33]

A non-transitory computer-readable recording medium with a program recorded thereon, the program comprising instructions for causing a computer that inspects a container filled with liquid to perform processes to:
control a first rotation process of setting the container in a posture laid on its side and rotating the container about a central axis of the container; and
acquiring an image before rotation and an image after rotation obtained by capturing a same predetermined region of the container with a camera before and after the first rotation process is performed, respectively.

### REFERENCE SIGNS LIST

1 inspection system
2 rotating unit
3 acquiring unit
100 inspection system
110 vial
200 grasping and rotating device
201 flat plate member
202 upper arm part
203 lower arm part
204 lower grasping part
205 transparent plate
206 chuck mechanism
207 motor
208 rotation shaft
209, 210 rotation angle detector
211 chuck finger
300-1, 300-2 lighting device
400-1, 400-2 camera device
500 information processing apparatus
510 communication I/F unit
520 operation input unit
530 storage unit
531 program
532 image information
533 inspection result information
540 arithmetic processing unit
541 grasp and rotation control unit
542 acquiring unit
543 detecting unit
544 display control unit
600 display device

What is claimed is:

1. An inspection system that inspects a container filled with liquid, the inspection system comprising:
a memory containing program instructions; and
a processor coupled to the memory, wherein the processor is configured to execute the program instructions to:
perform a first rotation process of setting the container in a posture laid on its side and rotating the container about a central axis of the container; and
acquire an image before rotation and an image after rotation obtained by capturing a same predetermined region of the container with a camera before and after the first rotation process is performed, respectively.

2. The inspection system according to claim 1, wherein the processor is further configured to execute the program instructions to:
in the acquiring the image before rotation, acquire the image before rotation from an image obtained by capturing with the camera while setting the container in an upright posture and rotating the container about the central axis; and
in the acquiring the image after rotation, acquire the image after rotation from an image obtained by capturing with the camera while setting the container in the upright posture and rotating the container about the central axis.

3. The inspection system according to claim 1, wherein the processor is further configured to execute the program instructions to:
in the acquiring the image before rotation, acquire the image before rotation from an image obtained by capturing with the camera while setting the container in the posture laid on its side and rotating the container about the central axis of the container; and
in the acquiring the image after rotation, acquire the image after rotation from an image obtained by capturing with the camera while setting the container in the posture laid on its side and rotating the container about the central axis of the container.

4. The inspection system according to claim 1, wherein the processor is further configured to execute the program instructions to
compare the image before rotation with the image after rotation, and detect a foreign object adhering to an inner wall of the container.

5. The inspection system according to claim 4, wherein the processor is further configured to execute the program instructions to
compare the image before rotation with the image after rotation, and detect a damage of the container.

6. The inspection system according to claim 1, wherein
the camera has an optical axis perpendicular to the central axis.

7. The inspection system according to claim 6, wherein
the predetermined region includes a body part of the container.

8. The inspection system according to claim 1, wherein
the camera has an optical axis parallel to the central axis.

9. The inspection system according to claim 8, wherein
the predetermined region includes a bottom surface region of the container.

10. The inspection system according to claim 8, wherein
the predetermined region includes a region of a back of a lid of the container.

11-16. (canceled)

17. An inspection method for inspecting a container filled with liquid, the inspection method comprising:
performing a first rotation process of setting the container in a posture laid on its side and rotating the container about a central axis of the container; and
acquiring an image before rotation and an image after rotation obtained by capturing a same predetermined region of the container with a camera before and after the first rotation process is performed, respectively.

18. The inspection method according to claim 17, comprising:
in the acquiring the image before rotation, acquiring the image before rotation from an image obtained by capturing with the camera while setting the container in an upright posture and rotating the container about the central axis; and
in the acquiring the image after rotation, acquiring the image after rotation from an image obtained by capturing with the camera while setting the container in the upright posture and rotating the container about the central axis.

19. The inspection method according to claim 17, comprising:
in the acquiring the image before rotation, acquiring the image before rotation from an image obtained by capturing with the camera while setting the container in the posture laid on its side and rotating the container about the central axis of the container; and
in the acquiring the image after rotation, acquiring the image after rotation from an image obtained by capturing with the camera while setting the container in the posture laid on its side and rotating the container about the central axis of the container.

20. The inspection method according to claim 17, further comprising
comparing the image before rotation with the image after rotation, and detecting a foreign object adhering to an inner wall of the container.

21. The inspection method according to claim 20, comprising
in the detecting, further comparing the image before rotation with the image after rotation, and detecting a damage of the container.

22. The inspection method according to claim 17, wherein
the camera has an optical axis perpendicular to the central axis.

23. The inspection method according to claim 22, wherein
the predetermined region includes a body part of the container.

24. The inspection method according to claim 17, wherein
the camera has an optical axis parallel to the central axis.

25-32. (canceled)

33. A non-transitory computer-readable recording medium with a program recorded thereon, the program comprising instructions for causing a computer that inspects a container filled with liquid to perform processes to:
control a first rotation process of setting the container in a posture laid on its side and rotating the container about a central axis of the container; and
acquiring an image before rotation and an image after rotation obtained by capturing a same predetermined region of the container with a camera before and after the first rotation process is performed, respectively.
